(19) United States
(12) Patent Application Publication
(10) Pub. No.: US 2002/0011023 A1
(43) Pub. Date: Jan. 31, 2002

(54) Tree stabilizing assembly

(76) Inventor: Dennis Ambrose, North Wales, PA (US)

Correspondence Address: DILWORTH PAXSON LLP, 3200 MELLON BANK CENTER, 1735 MARKET STREET, PHILADELPHIA, PA, 19103, US

(21) Appl. No.: 09/907,019

(22) Filed: Jul. 17, 2001

Related U.S. Application Data
(60) Provisional application No. 60/219,291, filed on Jul. 19, 2000.

(51) Int. Cl. A01G 1/00

(52) U.S. Cl. 47/42

(57) ABSTRACT

The present invention provides a tree staking system designed to support or provide supplementary bracing to a tree so as to maintain it in a substantially upright or other predetermined position when the tree is planted or replanted. More specifically, the subject tree staking assembly comprises at least one, but preferably two, or a plurality of support members. A tree strap assembly is used to removably, but securely, position the support members in spaced relation to one another about the circumference of a trunk of the tree being supported without actually encircling or girdling the tree. Consequently, the tree is not blemished or scarred. Advantageously, the assembly affords a system by which a tree can be supported in a predetermined, upright position by a single worker without the need for specialized parts or tools.

### CROSS-REFERENCE TO RELATED APPLICATIONS

This application claims priority to U.S. Provisional Application Ser. No. 60/219,291, filed in the U.S. Patent and Trademark Office on Jul. 19, 2000.

### TECHNICAL FIELD OF THE INVENTION

The present invention pertains generally to tree husbandry, and more particularly to apparatus for bracing or stabilizing newly transplanted trees or trees in wind-swept areas.

### BACKGROUND OF THE INVENTION

A newly transplanted tree must be braced or supported with stakes or with guy wires and anchors in order to allow the root system time to develop and sufficiently anchor the tree so that it does not tilt or fall under its own weight or as the result of wind. The conventional method of bracing newly transplanted trees is to use one or more rope or wire lines to brace the tree to two or three stakes in the ground near the tree. The lines are usually fastened to the tree trunk at least halfway up the trunk so that the lines have enough leverage on the trunk to maintain its stability in high winds.

It is well known that bracing lines have a tendency to saw or cut into the tree trunk as the tree sways in the wind causing girdling and/or trunk damage thus disfiguring the tree trunk and/or exposing the tree to the infiltration of insects or disease. Accordingly, garden hose is often used around the lines along their length where they engage the tree trunk directly to shield the trunk form the knifing action of the lines and to disperse the force of the engaging lines over a wider area of the trunk to avoid girdling. Nonetheless, because the hose tends to be made of relative flexible material the engaging force of the line or lines is still focused over a relatively small area of the hose and trunk underneath such that the hose also tends to saw into the tree trunk, although to a lesser degree than an uncovered line. Moreover, it is usually necessary to use some uncovered line to secure and tighten the covered line around the trunk at the desired height so that it does not slip down, particularly in the three point system in which the lines pull downwardly. If not properly fastened over and around the hose covered lines or if displaced these uncovered lines can engage and damage the trunk.

Aside from their tendency to girdle a tree trunk, conventional tree bracing techniques can be difficult to tighten into place, particularly for persons working alone, due to the difficulty in keeping the line synched around the trunk at its desired position while the ends of the lines are anchored to the stakes. While, the homeowner may have use for such a system, workers planting large numbers of trees along roads or in re-forestation areas have a need to work quickly and efficiently, and often they are working alone on each planting.

Accordingly, there is a need for a tree bracing system which avoids girdling and/or damage to the tree trunk and which is easy and efficient to implement for a worker operating alone, who must often plant more than a hundred trees in a day, each of which must be braced or staked into a stable, upright position.

### SUMMARY OF THE INVENTION

The present invention is directed towards a tree staking system designed to support or provide supplementary bracing to a tree so as to maintain it in a substantially upright or other predetermined position when the tree is planted or replanted. Such supplemental bracing is normally required during the replanting process and is usually continued until the roots of the tree take firm hold. More specifically, the subject tree staking assembly comprises at least one, but preferably two, or a plurality of support members. A tree strap assembly is used to removably, but securely, position the support members in spaced relation to one another about the circumference of a trunk of the tree being supported.

In the preferred embodiment, to be described in greater detail hereinafter, the attachment assembly comprises a woven strap, preferably formed of a high-strength flexible plastic material. Moreover, the strap comprises at the one end a nail and reinforcing washer assembly, which in use is capable of piercing the other end of the same strap after it has been wrapped around the tree and support members (stakes or posts), and the nail is then driven into one of the stakes. In practice, the strap is wrapped and twisted into a single or a double figure eight (“8”), such that the tree is encompassed within the two figure 8's, and securely held in place between the two stakes. The nail can be removed and the straps tightened if they become lose, or if the tree shifts or settles, or if the stakes move over time, then the nail is reinserted through the second end of the tree strap and hammered back into place on the stake. The woven material of the tree strap should not stretch.

The tree strap is positioned at the appropriate locations relative to the tree trunk being supported. Accordingly, the tree strap is easily and loosely fitted in surrounding relation to a predetermined segment of the tree trunk by a single individual, such that that fixed engagement between the support members and the tree is achieved, but tree itself is neither encircled by any member nor in any way damaged or injured by the process. Once the tree strap is positioned as desired, the nail can be easily removed and the strap “tightened,” then the nail is reinserted through the second end of the strap and reaffixed to the stake. This in turn forces a holds the tree in a fixed positioning relative to the support members without the need for guy wires or ropes or anchors into the ground about the tree trunk.

The double figure 8 assembly of the tree strap about the tree and support members engages the support members, without actually encircling or girdling the tree, even though a significant bracing force is applied to the tree trunk. The tree strap has no detrimental effect on the tree, thereby allowing exposure of the majority of the exterior surface portions of the tree trunk to air, water, etc. Again blemishing or marring of the exterior surface of a tree by elimination of the protective wrapping material is thereby eliminated.

To apply the proper bracing force to the tree trunk, the tree strap cooperatively engages each of the support members. More specifically, the tree strap has been reduced to such efficiency and simplicity that it eliminates the need for any additional components, and only a hammer or similar means for causing the nail to penetrate into the stake is required to fasten the nail into the stake. Alternately, a plurality of tree straps may be positioned to concurrently engage a tree to three or four support members.

Therefore, it is a primary object of the present invention to provide a staking system designed to support a tree in a predetermined, upright position, and which is capable of being installed or mounted in a bracing position by a single worker.

Another primary object of the present invention is to provide a staking system, which can be installed and removed from its operative, supporting position relative to a tree by a single person without the need for specialized parts or tools.

Yet another important object of the present invention is to provide a staking system which applies and maintains adequate bracing or supporting forces to the trunk portion of a tree about a circumference thereof without causing substantial blemishing or scarring of the tree trunk at the points of application of such supportive forces.

Still another important object of the present invention is to provide a staking system for a tree, wherein the operative, structural components are removably disposed in predetermined operative positions, and one end of the tree strap is fixedly attached to the other.

It is also an important object of the present invention to provide a staking system incorporating preferably two trunk-engaging support members, wherein the tree strap is easily and efficiently positionable at any point on the stake or about the circumference of a tree trunk without the need for more than one worker.

These and other objects, features and advantages of the present invention will become more clear when the drawings, as well as the detailed description, are taken into consideration.

### BRIEF DESCRIPTION OF THE DRAWINGS

In the drawings, like reference numerals indicate corresponding parts throughout the several views.

FIG. 1A-C is a view of the preferred embodiment of the present invention. FIG. 1A is a top view of the tree stabilizing assembly. FIG. 1B is a side view of the embodiment shown in FIG. 1A. FIG. 1C is a bottom view of the embodiment shown in FIGS. 1A and 1B.

FIG. 2A is a perspective view of the embodiment shown in FIG. 1, views A-C, illustrating the assembly as installed on a tree trunk and one stake. FIG. 2B is a perspective view of the embodiment shown in FIG. 2A, shown as attached to two stakes, as it is used in the preferred embodiment.

### DETAILED DESCRIPTION OF THE INVENTION

In the following detailed description of the preferred embodiments, references is made to accompanying drawings which form a part hereof, and in which is shown by way of illustration specific embodiments in which the invention may be practiced. These embodiments are described in sufficient detail to enable those skilled in the art to practice the invention and it is to be understood that other embodiments may be utilized and that structural changes may be made without departing from the scope of the present invention. The following detailed description is, therefore, not to be taken in a limiting sense, and the scope of the present invention is defined by the appended claims.

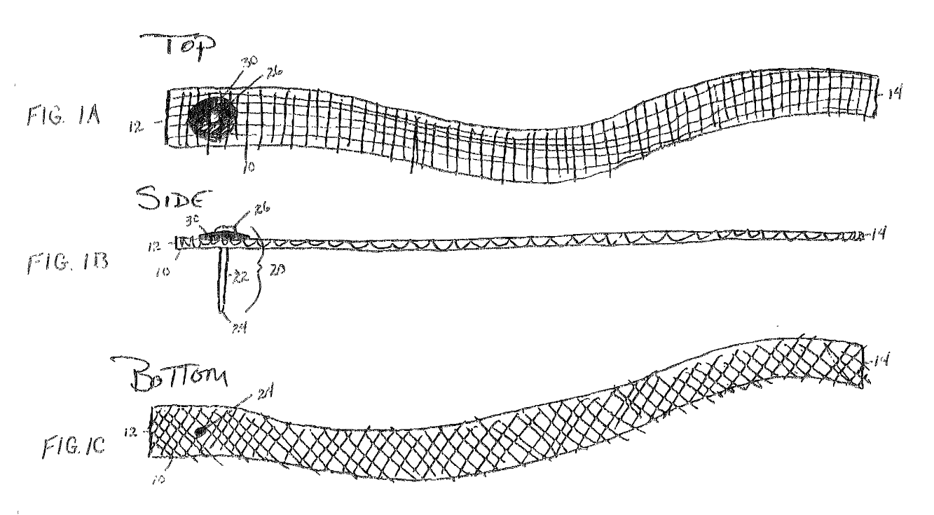

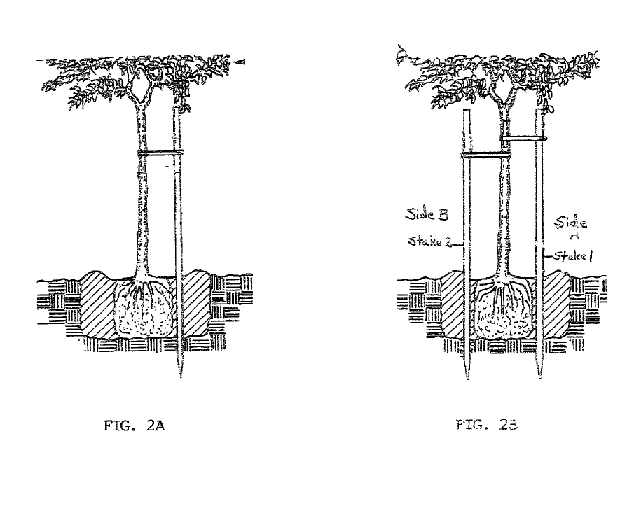

Referring now to the drawings, there is illustrated in FIGS. 1A through 1C an embodiment of a tree bracing strap 10 in accordance with the principles of the present invention. As shown in FIGS. 2A and 2B, the bracing strap 10 is used in connection with anchoring stakes or poles, preferably of wood or a similar porous, rigid material, to brace a newly planted or damaged tree. The tree strap 10 is of substantially flat, woven-textile construction, 060 in thickness, which is approximately 1/16^{th} inch thick.

The tree strap ranges from about 20-72 inches long, preferably 25-40 inches long, more preferably 30-35 inches long, most preferably 34 inches long if it is only intended to attach the tree to one of the plurality of stakes. If the strap is intended to form a double figure 8 and encircle the tree and two stakes, it is preferably 45-72 inches, in length, more preferably 60-70 inches in length, most preferably about 68 inches in length.

The strap is flexible in nature, yet relatively sturdy and durable; formed of woven material, preferably woven plastic material that will withstand adverse weather conditions for a substantial period of time. More preferably the strap is made of woven polyethylene or polypropylene. In one embodiment of the invention the tree strap is made of woven polypropylene produced by Tapecraft Corp (Anniston, Ala.). The weave of the strap must be sufficiently dense to support the tree without breaking or tearing under heavy winds, yet is must also be sufficiently open to permit a nail to past through without tearing or breaking the fibers of the strap.

The strap is ½ inch to 3 inches in width. Preferably, it is ½ inch to 1½ inches in width, more preferably approximately 1 inch in width. The preferred shape of the tree strap is an elongated rectangle of woven material, having equal widths of approximately 1 inch at each end. However, the strap could also be taped such that one end is wider than the other, or wide in the middle and tapering at either end.

A connecting member, such as a nail or tack 20 comprises and penetrates the first end 12 of the strap. In the simplest version of the strap, the pointed connecting member 20 has a body 22, ending in a point at one end 24, and a head at the other end 26. The head end 26 is preferably flattened to permit force, such as a hammer, to be applied to drive the pointed end 24 into the wooden stake. The preferred pointed connecting member is exemplified by a nail, more preferably a nail made of galvanized steel, which has a much longer life in adverse and wet weather conditions, than would other iron-based metals. Aluminum is also an acceptable material.

Preferably the pointed connecting member 20 is ¾ to ½ inches in length, more preferably approximately 1 inch, as represented by a standard 1″ galvanized nail.

Surrounding the nail 20 is a washer 30 affixed to the strap 10, preferably of plastic for durability, although galvanized metal would be acceptable. The size of the washer 30 may be of variable size and diameter, so long as the outer diameter of the washer does not exceed the width of the strap 10, and so long as inner diameter of the washer is of sufficient size to permit the body of the nail 22 to pass through, while at the same time being sufficiently narrow so that the head of the nail 26 cannot pass through the washer 30.

In use, the strap of the preferred embodiment has two ends, the first end 12 comprises a 1″ galvanized nail 20, with a plastic washer 30 surrounding the nail. A combination galvanized nail and plastic washer of the preferred size and shape is produced by B-Cap Ent. (Western, N.C.). The combination is affixed to the woven strap 10, such that the center point of the nail is approximately 1 inch from the first end of the strap 12. The opposite or second end of the length of the woven strap 14 contains no additional parts or components. The second end comprises only the textile material of the woven tree strap.

In practice, one or more wooden stakes or posts 40 are forced or hammered into the ground alongside the tree being staked or braced. Each stake 40 is typically of a length, whereby after inserting into the ground, it is about equal in height to the trunk of the tree being supported. The stake may be of any practical diameter, and such stakes are well known to those of ordinary skill in the art. After the stake(s) 40 are in place, the practitioner holds the second end 14 of the strap 10 against the stake 40, then wraps the first end 12 of the strap 10 around the tree, approximately parallel to the ground, while the second end 14 of the strap 10 remains held against the stake 40. The first end 12, having surrounded the tree is then returned to the point on the stake 40 where the second end 14 is held. Then, the point 24 of the nail 20 of the first end 12 of the strap 10 is placed through the woven material of the second end 14 of the strap and forced (hammered) into the stake. Thus, when forced into the stake, the nail 20 holds both the first end 12 and the second end 14 of the woven strap 10 firmly, but removably, in place against the stake, and the tree is encompassed by the woven strap 10 approximately parallel to the ground, thereby also bracing it against the stake. See FIG. 2A.

The height of the tree stake on the tree is preferably on the upper half of the trunk, typically about ⅔ to ¾ of the way up the tree. However, such distances would be readily apparent to those familiar with the practice of tree husbandry.

In a preferred embodiment of the invention, two (2) stakes are used, one on either side of the tree, about equally spaced from each other in each direction. The stakes are each placed at a distance from the tree that would be readily recognized by one accustomed to such staking procedures. Simple mathematics will determine the proper placement of the stakes with regard to the tree.

With two stakes, the woven strap is wrapped around the tree parallel to the ground, and fastened as previously described. However, the strap can be used in two different embodiments to accomplish stabilization.

For example, in a first embodiment, using two 34″ straps as shown in FIG. 2B, strap 1 begins at stake 1 (A). For the first tree strap (A), the second end 14 of the tree strap 10 is held against stake 1 (A), then the first end 12 is wrapped around the tree and crossed to the opposite side of the original first stake (A) (essentially forming a figure 8). When the first end 12 of the strap returns to and overlaps the second end 14 of the strap, which had been held in place against the first stake (A), the nail at the first end 12 of strap 10 is then driven through the second end 14 into the stake. This process is repeated for the second tree strap (B). The second end 14 of strap B is held against stake 2 (B), then the first end 12 is wrapped around the tree and crossed to the opposite side of stake 2 (B) (essentially forming a figure 8). When the first end 12 of the strap returns to and overlaps the second end 14 of the strap, which had been held in place against the stake 2 (B), the nail at the first end 12 of strap 10 is then driven through the second end 14 into the stake. Thus, the two tree straps operate cooperatively in stabilizing the tree with stakes 1 and 2.

In an alternative embodiment, a long strap of 60-70 inches is used with the two stakes 1 and 2 placed about equidistant from each other on either side of the tree. The strap begins at stake 1 (A), and the second end 14 of the tree strap 10 is held against stake 1 (A). Then the first end 12 crosses to the other side of the tree (in half of a figure 8), after which is again crosses to the opposite side of stake 2 (B) (again forming half of a figure 8). The first end 12 of the strap wraps around the stake 2, crosses back to the other side of the tree (completing the figure 8 on the B side of the tree), after which is again crosses to the opposite side of the original stake 1 (again completing the figure 8 on the A side of the tree). Finally, the first end 12 of the strap returns to and overlaps the second end 14 of the strap, which had been held in place against the original stake 1 (A). The nail at the first end 12 of strap 10 is then driven through the second end 14 into the stake.

Regardless of the length of the strap, the distance into the second end into which the nail is placed, is adjustable and is a factor based upon the distance between the tree and the stakes, the size of the tree, the size of the stakes and the distance between the stakes and the tree. Moreover, the adjustable nature of the placement of the nail 20 is advantageous, since any slack in the strap 10 can be taken up as the tree settles or as the stakes shift.

In practice, if the tension on the strap 10 needs to be tightened, the nail can be easily removed from the stake, the strap 10 pulled tight, and the nail reset through the second end 14 of the strap and hammered into the stake. The washer 30 surrounding the nail 20 where it passes through the first end 12 of the strap 10, acts as reinforcement, thereby preventing the nail 20 from tearing through the strap either vertically or horizontally, and permits the nail to be moved or tightened without damaging or destroying the strap.

In embodiments not shown in the drawings, the tree strap could be combined with guy wires or ropes, or with anchors. Also more than one strap can be used to stabilize a tree against each stake. Moreover, more than two tree straps could be used simultaneously on the same tree, as needed. For example, four (4) stakes could be used to support a tree being placed in particularly difficult terrain or high wind, and the tree could be fastened to one set of stakes by one tree strap, while at the same time, the tree could also be fastened to a second set of stakes by a second tree strap. In the alternative for larger tree trunks, using only two stakes, two tree straps could be used. A first tree strap would extend from the first stake around the tree and stop at the second stake, while a second tree strap would extend from the second stake, around the tree and end at the first stake. The nail of the first end of strap 1 would fasten the second end of strap 2 to the second stake, while the nail of the first end of strap 2 would fasten the second end of strap 1 to the first stake.

Advantageously by the present method no rope, assembly or device actually encircles the tree. Therefore, the tree is completely shielded from damage caused by the cutting or sawing of the force of a bracing line into the tree trunk. Moreover, as the diameter of the tree increases, the strap cannot cut into or girdle the tree itself, thereby avoiding the trunk damage problems that have been long present in prior art techniques, which tend to focus the bracing forces over a relatively small surface area of the tree defined by the width of the bracing lines and/or hose covered lines.

The preferred embodiment is particularly desirable for use where traditional three point anchoring is not possible, for instance on a boulevard where the street, sidewalk or driveway prevents three-point placement of stakes. This embodiment is also preferred for use in public areas such as parks where the ropes and stakes of the three-point system are undesirably hazardous to those walking or running near the braced tree.

As may be readily appreciated, embodiments of the present invention are advantageous over the prior art method of bracing trees by the use of wires, ropes and hoses. For instance, the tree strap of the present invention may be readily positioned on a tree in a single, simple step, and remains self-engaged until it is tightened or removed. No additional parts or components are required. The strap can be fastened with one hand while the other supports the tree. The nail cannot be dropped or lost because it is permanently attached to the strap. The entire assembly is extremely simply to attach and yet lightweight, making it possible for a single person to carry many of the tree straps over a distance without effort, and to use them without assistance. The simplicity of the tree strap system permits large numbers of the device to be produced quickly, at a very low cost, without the need for costly manufacturing machinery or a large number of workers.

No bracing ropes or wires need to be attached or anchored to the ground, thus making the tree strap system highly useful in sandy or shifting soil, or in soft muddy areas. This is in contrast with the less convenient prior art techniques in which the bracing ropes or lines must be used to hold the tree, and the tree must be held in place by a second person while the lines are secured to the anchoring stakes in the ground. Accordingly, the present invention provides a system for anchoring trees, which is easy to carry and fasten into place, which can be manipulated quickly and easily by a single person working alone, and which protects the tree from disfigurement or from damage of the type which might otherwise lead to susceptibility to disease or insect penetration.

While the present invention has been described in connection with the preferred embodiment thereof, it will be understood that many modifications will be readily apparent to those of ordinary skill in the art, and this application is intended to cover any adaptations or variations thereof. Therefore, it is manifestly intended that this invention be limited only by the claims and the equivalents thereof.

What is claimed is:

1. A tree stabilizing assembly, comprising (i) a woven textile rectangle having two opposing long sides ranging in length from 20 to 72 inches, and two opposing short sides ranging in length from ½ to 3 inches wide, wherein the short sides form the two ends of the assembly, a first end and a second end, (ii) a single connecting member, which is permanently affixed approximately 1 inch from the first end of the rectangle and equidistant from each long side of the rectangle, wherein said connecting member has a pointed end and a flattened head end, and wherein the connecting member is made of galvanized material, said connecting member is oriented with the flattened head end adjacent to the woven textile, and with the pointed end extending outward through the woven textile and perpendicular thereto, and (iii) a reinforcing member is permanently affixed to the woven textile in a position surrounding the single connecting member at the first end of the rectangle, such that the reinforcing member rests between and is at all times in contact with the woven textile and the flattened head end of the connecting member.

2. An assembly of claim 1, wherein the textile is polyethylene or polypropylene.

3. An assembly of claim 2, wherein the textile is polypropylene.

4. An assembly of claim 1, wherein the textile rectangle is approximately 34 inches long by 1 inch wide.

5. An assembly of claim 1, wherein the connecting member is a galvanized nail.

6. An assembly of claim 5, wherein the connecting member is a 1 inch galvanized nail.

7. An assembly of claim 1, wherein the reinforcing member is a washer.

8. An assembly of claim 1, wherein the reinforcing member is plastic.

9. A method of stabilizing a tree using the stabilizing assembly of claim 1, comprising the following steps in association with a newly planted tree:
a) inserting a stake into the ground alongside of, and parallel to, the tree;
b) holding the second end of the woven rectangle against the stake on the side of the stake furthest away from the tree;
c) wrapping the first end of the rectangle around the tree in a figure eight orientation parallel to the ground, and returning the first end of the rectangle to contact the second end of the rectangle which was held against the far side of the stake;
d) inserting the pointed end of the connecting member on the first end of the rectangle through the second end of the rectangle and into the stake; and firmly, but removably, forcing the pointed end of the connecting member into the stake.

10. The method of claim 9, wherein two stakes are placed equidistantly on opposite sides of the tree, and wherein two stabilizing assemblies are used and the process is repeated, such that the first assembly affixes the tree to stake 1, and the second assembly affixes the tree to stake 2.

11. A method of stabilizing a tree using the stabilizing assembly of claim 1, comprising the following steps in association with a newly planted tree:
a) inserting a stake 1 into the ground alongside of, and parallel to, the tree;
b) inserting a second stake 2 into the ground alongside of, and parallel to, the tree, in an orientation opposite from and equidistant from the first stake 1;
c) holding the second end of the woven rectangle against stake 1 on the side of the stake furthest away from the tree;
d) wrapping the first end of the rectangle around the tree in one half of a figure eight orientation parallel to the ground, and continuing to the opposite side of the second stake 2 in one half of a figure eight orientation parallel to the ground, continuing around stake 2, then returning the first end of the rectangle to the opposite side of the tree, thereby completing the second figure eight, and returning the first end to the opposite side of stake 1, thereby completing the second figure eight;
e) contact the first end of the rectangle with the second end of the rectangle which was held against the far side of stake 1;
f) inserting the pointed end of the connecting member on the first end of the rectangle through the second end of the rectangle and into the stake; and
g) firmly, but removably, forcing the pointed end of the connecting member into the stake.

12. The method of claim 9, comprising a plurality of stakes and an equal number of stabilizing assemblies used to affix the tree to the plurality of stakes, wherein one assembly is affixed to each stake.

13. The method of claim 11, comprising a plurality of stakes and an equal number of stabilizing assemblies used to affix the tree to the plurality of stakes, wherein one assembly is affixed to each stake.

14. A tree stabilizing system, wherein at least one stake is inserted into the ground alongside of, and parallel to, a newly planted tree, and the tree is supported by the at least one stake using the tree staking assembly of claim 1.

15. A tree stabilizing system, wherein at least two stakes are inserted into the ground alongside of, and parallel to, equidistantly on opposite sides of a newly planted tree, and the tree is supported by the at least two stakes using the tree staking assembly of claim 1, such that the first assembly affixes the tree to stake 1, and the second assembly affixes the tree to stake 2.

16. A tree stabilizing system of claim 15, comprising a plurality of stakes and an equal number of stabilizing assemblies used to affix the tree to the plurality of stakes, wherein one assembly is affixed to each stake.
